(19) United States
(12) Patent Application Publication
(10) Pub. No.: US 2012/0325962 A1
(43) Pub. Date: Dec. 27, 2012

(54) Window-less transport aircraft

(76) Inventor: Wesley I. Barron, Kamloops (CA)

(21) Appl. No.: 13/385,188

(22) Filed: Feb. 7, 2012

Related U.S. Application Data
(60) Provisional application No. 61/571,329, filed on Jun. 27, 2011.

(51) Int. Cl. B64D 11/00; B64C 1/00

(52) U.S. Cl. 244/118.5

(57) ABSTRACT

Transport aircraft with passenger windows are a relatively complex add-on to the design of a fuselage. These windows are only for cosmetic features to give passengers who sit nearby comfort. They can take away natural strength attributes of the simple design of a tubular fuselage shape. The need for windows also restricts more complex pressurized fuselage shapes such as full blended wings and flying wings for passenger uses. The deletion of windows will save design, weight and construction costs. Substituting cameras for windows removes many design and construction restrictions currently imposed by the demand for passenger windows.

### FIELD OF THE INVENTION

This invention relates to the design and production of window-less passenger transport aircraft.

### BACKGROUND OF THE INVENTION

Since the invention of the aircraft, passengers expected to see outside the fuselage or the body of the machine. Most if not all design engineers created passenger aircraft with windows. In unpressurized aircraft the added weight of the window frame and the window lens was not a serious constraint to its construction costs, nor did it take away much if any strength from the fuselage. Later aircraft uses demanded pressurized fuselages for transport aircraft flying at elevations greater than 10 thousand feet above sea level. Aircraft are inherently more efficient when flying at higher altitudes as there is less airframe drag from air particles and thus less fuel is used per unit of distance flown.

Because the fuselages in all transport aircraft are now pressurized, the design of a passenger window is more complex, massive and expensive. The fuselage design (circular or oval shaped tubes) lost its natural inherent strength because of the openings and engineers had to add more structure around the openings adding heavier and stronger window panes thus more overall weight. More maintenance is required because the windows collect moisture and the moisture begets corrosion. The final consideration is the added manufacturing costs associated with incorporating windows into the aircraft fuselages.

In reality, windows, in large passenger aircraft are there for only passenger view and comfort reducing the claustrophobic effect one may get in a confined tubular designed passenger compartment. The need for windows restricts the aircraft designers to move away from tube shape fuselages.

Recent designs have even enlarged the windows to mask the tubular shape of the cabin area of the fuselage and thus the result is heavier window frames and stronger & heavier window lenses. There is an oxymoronic issue about the new designs being too heavy and the need to be lighter and yet the need for larger, thus heavier, windows. The windows alone can add many percentile of weight to the gross empty weight of the aircraft. A heavy aircraft is one that is less efficient and will consume more fuel to maintain a similar time to destination as compared to lighter weight aircraft.

Passengers are generally hostile to the idea of a window-less cabin and the general attitude amongst the airframe designers is to make the cabin areas (fuselages) more open and lighted. Thus any move away from tubular designs presents substantial issues to present an appealing passenger cabin to the travelling public.

Research studies have shown that ‘blended wing’ and ‘flying wing’ aircraft are more efficient at altitudes above 25000 feet ASL (above sea level) compared to the tubular designs. Those designs are not conducive to passenger cabins with windows as the pressurized cabin and cockpit areas must be inside the wing area and would not be near any outer wall (which would be the wing) of the aircraft frame. There is thus reluctance by the airlines to endorse such ideas.

There is a need for a new method of creating a passenger cabin in transport window-less aircraft that will give people the impression that a window is in the expected location and the view is of the surrounding environment of the aircraft. The utilization of blended wing and flying wing designs could be commercially appealing if such a window in a synthetic form could be provided.

### OBJECTS OF THE INVENTION

The invention allows for the construction of a window-less passenger transport aircraft displacing windows along the external walls of an aircraft fuselage with synthetic or virtual windows, located at the expected positions and intervals along the walls of the cabin area.

The invention teaches the use of small light weight cameras and various display systems and a facility to transmit the images to each passenger's personal electronic recording device.

The invention teaches the use of the window shade that is currently used in passenger aircraft to act as a control switch for the camera and display in a window-less passenger aircraft. Open the window shade and the display is activated and close the shade and the display is turned off.

### SUMMARY OF THE INVENTION

The invention's use of cameras and display systems to replace the windows on a passenger transport aircraft of any size, shape or weight category.

The invention's use of the current passenger interior mouldings and outlines for the electronic LCD (liquid crystal display) or OLED (organic light emitting display) displays at each passenger seat near the outer walls of the passenger compartment.

The invention's use of window blinds to control the camera and display on/off control.

The invention's use of the camera & display output for capturing and saving of images on passenger personal electronic devises.

What is claimed:

1. To substitute an electronic digital imaging and display system for passenger windows in pressurized transport aircraft of any size, shape and weight category. The view captured and transmitted by the camera would be nearly the same view or could be an enhanced view that a passenger would see outside of the fuselage when peering through the window.

2. Relative to claim #1, use of digital cameras using CCD, CMOSS or other similar technologies being of low cost and small sizes and its related various data transmissions methods.

3. Relative to claim#1, the camera(s) can be located at any location on the airframe which will provide an appropriate view relative to what each passenger would expect to see from their seat position.

4. Relative to claim #1, the camera lens can be of the type that will capture a narrow or wide angle and or produce large numbers of pixels that can be panned and or enlarged by the passenger on or at the display.

5. Relative to claim #1, the camera transmission cables can be optical fibre, metal or other suitable material embedded in composite skins of the aircraft components (i.e. wing tips, wings) or simply strung through the structure and connected to the adjacent part via standard fibre optic connection devices or other types of connection devices appropriate for the type of transmission material used or fastened to the surfaces of the aircraft.

6. Relative to claim #1, the display system can be incorporated inside the pressure hull of the aircraft at the former window position and be the same size or larger to simulate the window.

7. Relative to claim #1, the display can be a liquid crystal screen system or OLED (organic light emitting diode) system or any other light weight suitable display.

8. Relative to claim #7, the display can be of the type that will allow a passenger to pan or zoom in or out.

9. Relative to claim #7, the display can also be the entertainment system used in each passenger seat or compartment to provide a choice views especially for those passengers sitting in a seat or compartment not adjacent to a former window area.

10. Relative to claim #4, the display can be sent to a passenger's personal electronic device for capturing and saving via wireless, wired or optical transmission methods.

11. The window shade currently used, be used to obscure the image display and or stop the transmission of the data from the camera or cut the power source to the camera system, as described in claim #1.

12. The window shade and framing currently used may provide the outline of the display as reference in claim #1 and claim #7.
